(19) United States
(12) Patent Application Publication
(10) Pub. No.: US 2016/0050426 A1
(43) Pub. Date: Feb. 18, 2016

(54) LOSSLESS-CODING-MODE VIDEO ENCODING METHOD AND DEVICE, AND DECODING METHOD AND DEVICE

(71) Applicant: SAMSUNG ELECTRONICS CO., LTD., Suwon-si Gyeonggi-do (KR)

(72) Inventors: Yin-ji PIAO, Suwon-si (KR); Jung-hye MIN, Yongin-si (KR)

(73) Assignee: SAMSUNG ELECTRONICS CO., LTD., Gyeonggi-do, Suwon-si (KR)

(21) Appl. No.: 14/759,323

(22) PCT Filed: Jan. 6, 2014
(86) PCT No.: PCT/KR2014/000104

§ 371 Date: Oct. 23, 2015

Related U.S. Application Data
(60) Provisional application No. 61/748,835, filed on Jan. 4, 2013.

(51) Int. Cl. H04N 19/44; H04N 19/60; H04N 19/93; H04N 19/463; H04N 19/91

(52) U.S. Cl. CPC H04N 19/44; H04N 19/463; H04N 19/91; H04N 19/93; H04N 19/60

(57) ABSTRACT

Provided is an encoding method for encoding a last position of a significant transformation coefficient in lossless coding, according to an exemplary embodiment, the encoding method including: performing scanning from a first point to a second point of a coding unit in a predetermined order to obtain a transformation coefficient included in the coding unit; determining a last position of a significant transformation coefficient that is not 0 from among transformation coefficients included in the coding unit; determining position information corresponding to the determined last position with respect to the second point; and encoding the determined position information.

### FIELD OF THE INVENTION

The inventive concept relates to encoding and decoding of video in lossless coding, and more particularly, to a method and apparatus for encoding and decoding a last position of a significant transformation coefficient in loss coding.

### BACKGROUND ART

According to image compression methods such as MPEG-1, MPEG-2, or MPEG-4 H.264/MPEG-4 advanced video coding (AVC), an image is split into blocks having a predetermined size, and then, residual data of the blocks is obtained by inter prediction or intra prediction. Residual data is compressed by transformation, quantization, scanning, run length coding, and entropy coding. In entropy coding, a syntax element such as a transformation coefficient or a prediction mode is entropy encoded to output a bit stream. A decoder parses the symtax elements from the bit stream to thereby extract the syntax elements, and reconstructs an image based on the extracted syntax elements.

### DETAILED DESCRIPTION OF THE INVENTION

### Technical Problem

Meanwhile, a process of quantizing residual data described above may be bypassed in lossless image compression methods. Alternatively, both transformation and quantization may be bypassed. When both transformation and quantization are bypassed, residual data itself may be entropy encoded like a transformation coefficient. However, a last position of a significant transformation coefficient or significant residual data according to the related art is entropy encoded based on a low-frequency region (an upper left corner of a coding unit), and thus the problem exists that a value of the last position is always large in lossless image compression methods. That is, in lossless image compression methods, a length of a bit required to encode the last position is increased.

### Technical Solution

The inventive concept provides a method and apparatus for efficiently encoding and decoding a last position of a significant transformation coefficient or residual data in lossless image compression methods.

The technical objects of the inventive concept are not limited to features described above, and other technical objects not described herein may be obviously understood by one of ordinary skill in the art from description provided below.

### Advantageous Effects of the Invention

As described above, according to the method of encoding and decoding a last position of a significant transformation coefficient according to an exemplary embodiment, an encoding size of entropy coding corresponding to a last position of a significant transformation coefficient may be reduced, and a speed of encoding and decoding may be increased.

### BRIEF DESCRIPTION OF THE DRAWINGS

The above and other features and advantages of the inventive concept will become more apparent by describing in detail exemplary embodiments thereof with reference to the attached drawings in which:

FIG. 1 is a block diagram of an apparatus for encoding a video, according to an exemplary embodiment;

FIG. 2 is a block diagram of an apparatus for decoding a video, according to an exemplary embodiment;

FIG. 3 is a diagram for describing a concept of coding units according to an exemplary embodiment;

FIG. 4 is a detailed block diagram of a video encoding apparatus based on coding units having a hierarchical structure, according to an exemplary embodiment;

FIG. 5 is a detailed block diagram of a video decoding apparatus based on coding units having a hierarchical structure, according to an exemplary embodiment;

FIG. 6 is a diagram illustrating deeper coding units according to depths, and partitions, according to an exemplary embodiment of the inventive concept;

FIG. 7 is a diagram for describing a relationship between a coding unit and transformation units, according to an exemplary embodiment of the inventive concept;

FIG. 8 is a diagram for describing encoding information of coding units corresponding to a coded depth, according to an exemplary embodiment of the inventive concept;

FIG. 9 is a diagram of deeper coding units according to depths, according to an exemplary embodiment;

FIGS. 10 through 12 are diagrams for describing a relationship between coding units, prediction units, and frequency transformation units, according to an exemplary embodiment of the inventive concept;

FIG. 13 is a diagram for describing a relationship between a coding unit, a prediction unit, and a transformation unit, according to encoding mode information of Table 1;

FIG. 14A is a block diagram illustrating an apparatus for encoding a last position of a significant transformation coefficient or significant residual data in lossless coding according to an exemplary embodiment;

FIG. 14B is a flowchart of a method of encoding a last position of a significant transformation coefficient in lossless coding according to an exemplary embodiment;

FIG. 14C is a flowchart of a method of encoding a last position of significant residual data in lossless coding according to an exemplary embodiment;

FIG. 15 illustrates an example of obtaining a transformation coefficient included in a transformation unit;

FIG. 16 is a diagram for describing bits needed according to sizes of syntax elements corresponding to a last position of a significant transformation coefficient according to an exemplary embodiment;

FIG. 17 illustrates an example of determining a syntax element corresponding to a last position of a significant transformation coefficient according to an exemplary embodiment;

FIG. 18A is a block diagram illustrating an apparatus for decoding a last position of a significant transformation coefficient or significant residual data in lossless coding according to an exemplary embodiment;

FIG. 18B is a flowchart of a method of decoding a last position of a significant transformation coefficient in lossless coding according to an exemplary embodiment; and

FIG. 18C is a flowchart of a method of decoding a last position of significant residual data in lossless coding according to an exemplary embodiment.

### BEST MODE

According to an aspect of the inventive concept, there is provided an encoding method for encoding a last position of a significant transformation coefficient in lossless coding, the encoding method including: performing scanning from a first point to a second point of a coding unit in a predetermined order to obtain a transformation coefficient included in the coding unit; determining a last position of a significant transformation coefficient that is not 0 from among transformation coefficients included in the coding unit; determining position information corresponding to the determined last position with respect to the second point; and encoding the determined position information.

The position information according to an exemplary embodiment may be a value corresponding to a distance from the second point to the determined last position.

The position information according to an exemplary embodiment may be coordinate values corresponding to the determined last position with respect to the second point as the origin.

According to an exemplary embodiment, the first point may be an upper left corner of the coding unit, and the second point is lower right corner of the coding unit.

According to an exemplary embodiment, the first point may be a low frequency position of the coding unit, and the second point may be a high frequency position of the coding unit or a position corresponding to the high frequency position.

The encoding method for encoding a last position according to an exemplary embodiment may further include encoding a transformation coefficient included in the coding unit from the determined last position in a reverse order to the predetermined order.

The transformation coefficient according to an exemplary embodiment may be residual data on which DCT (Discrete cosine transform) is performed.

According to another aspect of the inventive concept, there is provided a decoding method for decoding a last position of a significant transformation coefficient in lossless coding, the decoding method including: obtaining position information corresponding to a last position of a significant transformation coefficient included in a coding unit from a bit stream; and determining the last position based on the obtained position information, wherein the obtained position information is a value corresponding to a distance from a high frequency region of the coding unit to the last position.

The position information according to an exemplary embodiment may indicate a last position of the significant transformation coefficient with respect to the lower right corner of the coding unit.

The position information according to an exemplary embodiment may be coordinate values corresponding to the last position having a lower right corner of the coding unit as the origin.

The decoding method according to an exemplary embodiment may further include decoding a transformation coefficient included in the coding unit from the determined last position.

According to another aspect of the inventive concept, there is provided an encoding apparatus for encoding a last position of a significant transformation coefficient in lossless coding, the encoding apparatus including: a scanner configured to perform scanning from a first point to a second point of a coding unit in a predetermined order to obtain a transformation coefficient included in the coding unit; a last position determiner configured to determine a last position of a significant transformation coefficient that is not 0 from among coefficients included in the coding unit; a position information determiner configured to determine position information corresponding to the determined last position with respect to the second point; and an encoder configured to encode the determined position information.

The position information according to an exemplary embodiment may be a value corresponding to a distance from the second point to the determined last position.

The encoder according to an exemplary embodiment may encode a transformation coefficient included in the coding unit from the determined last position in a reverse order to the predetermined order.

According to another aspect of the inventive concept, there is provided a decoding apparatus for decoding a last position of a significant transformation coefficient in lossless coding, the decoding apparatus including: a position information obtaining unit configured to obtain position information corresponding to a last position of a significant transformation coefficient included in a coding unit from a bit stream; and a last position determiner configured to determine the last position of the significant transformation coefficient based on the obtained position information, wherein the obtained position information is a value corresponding to a distance from a high frequency region of the coding unit to the last position.

The decoding apparatus according to an exemplary embodiment may further include a decoder for decoding a transformation coefficient included in the coding unit from the determined last position.

According to another aspect of the inventive concept, there is provided an encoding method for encoding a last position of a significant transformation coefficient in lossless coding, the encoding method including: performing scanning from a first point to a second point of a coding unit in a predetermined order to obtain residual data included in the coding unit; determining a last position of significant residual data that is not 0 from among residual data included in the coding unit; determining position information corresponding to the determined last position with respect to the second point; and encoding the determined position information.

According to another aspect of the inventive concept, there is provided a decoding method for decoding a last position of significant residual data in lossless coding, the decoding method including: obtaining position information corresponding to a last position of significant residual data included in a coding unit from a bit stream; and determining the last position based on the obtained position information, wherein the obtained position information is a value corresponding to a distance from a high frequency region of the coding unit to the last position.

In addition, other methods or systems for implementing the inventive concept and a computer readable recording medium having recorded thereon a program for executing the methods described above may further be provided.

### Mode of the Invention

The inventive concept will now be described more fully hereinafter with reference to the accompanying drawings, in which exemplary embodiments of the inventive concept are shown.

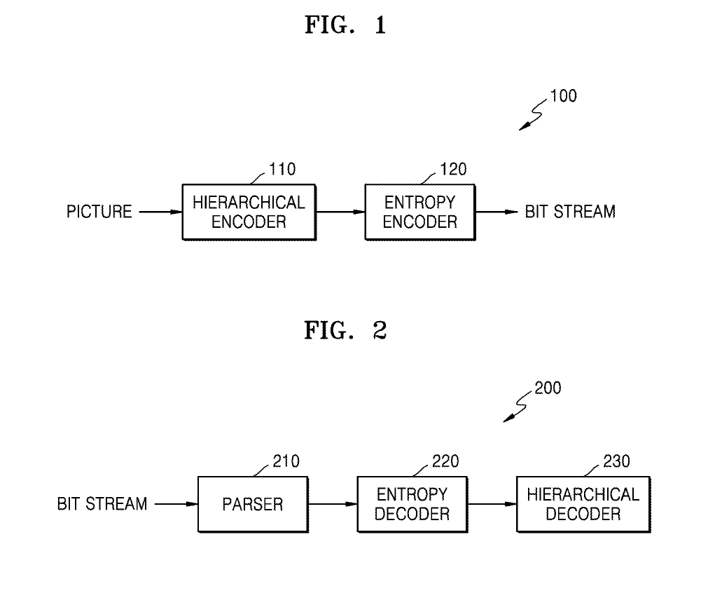

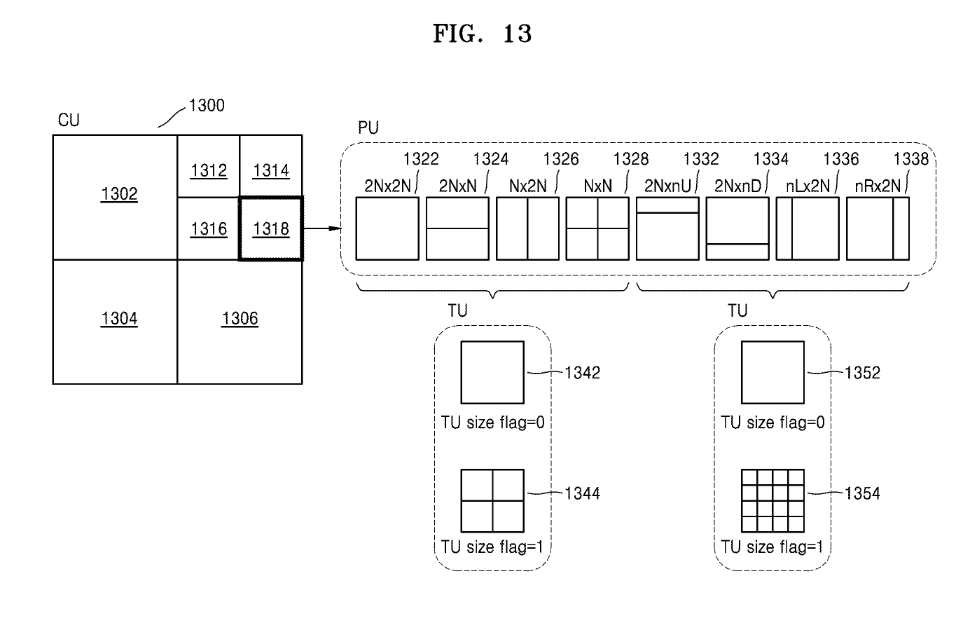

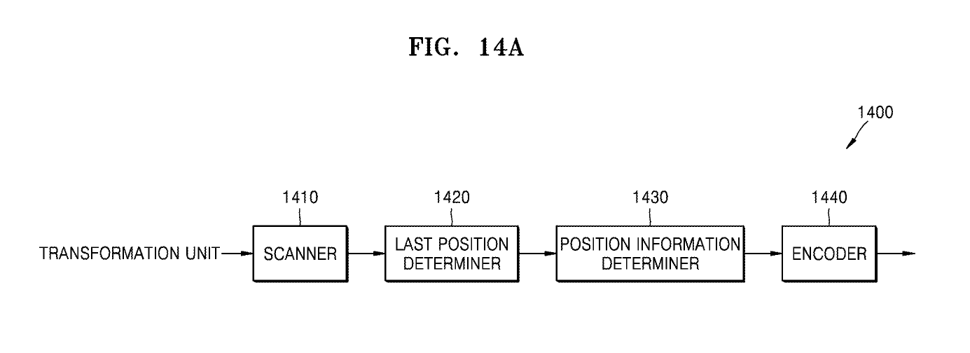

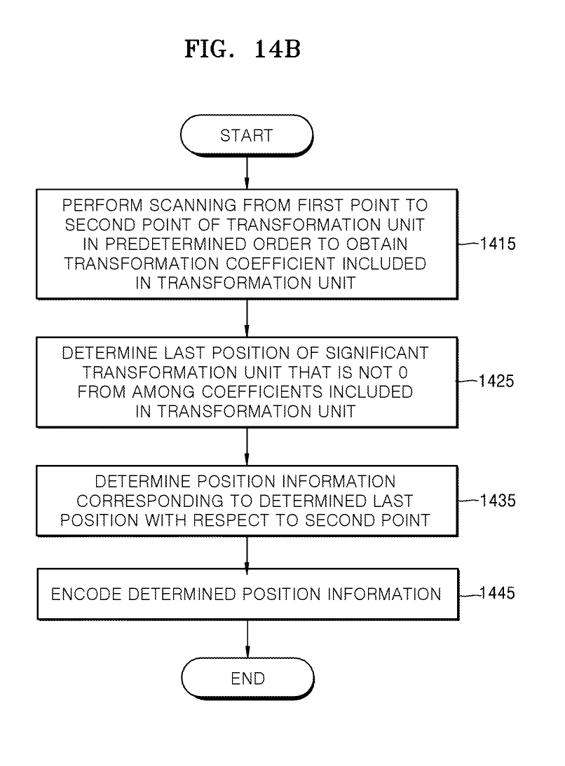

First, a method and apparatus for encoding and decoding of video based on a coding unit having a hierarchical tress, according to an exemplary embodiment of the inventive concept, will be described with reference to FIGS. 1 through 13. In addition, an operation of encoding and decoding a last position of a significant transformation coefficient or significant residual data in the method of encoding and decoding a video described with reference to FIGS. 1 through 13 will be described in detail with reference to FIGS. 14A through 18B.

FIG. 1 is a block diagram of a video encoding apparatus according to an exemplary embodiment.

The video encoding apparatus 100 according to an exemplary embodiment includes a hierarchical encoder 110 and an entropy encoder 120.

The hierarchical encoder 110 may split a current picture to be encoded, in units of predetermined data units to perform encoding on each of the data units. In detail, the hierarchical encoder 110 may split a current picture based on a maximum coding unit, which is a coding unit of a maximum size. The maximum coding unit according to an exemplary embodiment of the inventive concept may be a data unit having a size of 32×32, 64×64, 128×128, 256×256, etc., wherein a shape of the data unit is a square which has sides that are each a power of 2 and is greater than 8.

A coding unit according to an exemplary embodiment may be characterized by a maximum size and a depth. The depth denotes the number of times the coding unit is spatially split from the maximum coding unit, and as the depth deepens, deeper encoding units according to depths may be split from the maximum coding unit to a minimum coding unit. A depth of the maximum coding unit is an uppermost depth and a depth of the minimum coding unit is a lowermost depth. Since a size of a coding unit corresponding to each depth decreases as the depth of the maximum coding unit deepens, a coding unit corresponding to an upper depth may include a plurality of coding units corresponding to lower depths.

As described above, image data of the current picture is split into the maximum coding units according to a maximum size of the coding unit, and each of the maximum coding units may include deeper coding units that are split according to depths. Since the maximum coding unit according to an exemplary embodiment is split according to depths, the image data of a spatial domain included in the maximum coding unit may be hierarchically classified according to depths.

A maximum depth and a maximum size of a coding unit, which limit the total number of times a height and a width of the maximum coding unit are hierarchically split, may be predetermined.

The hierarchical encoder 110 encodes at least one split region obtained by splitting a region of the maximum coding unit according to depths, and determines a depth to output finally encoded image data according to the at least one split region. In other words, the hierarchical encoder 110 determines a coded depth by encoding the image data in the deeper coding units according to depths, according to the maximum coding unit of the current picture, and selecting a depth having the least encoding error. The determined coded depth and the encoded image data according to maximum encoding units are output to the entropy encoder 120.

The image data in the maximum coding unit is encoded based on the deeper coding units corresponding to at least one depth equal to or smaller than the maximum depth, and results of encoding the image data are compared based on each of the deeper coding units. A depth having the least encoding error may be selected after comparing encoding errors of the deeper coding units. At least one coded depth may be selected for each maximum coding unit.

The size of the maximum coding unit is split as a coding unit is hierarchically split according to depths and as the number of coding units increases. Also, even if coding units correspond to a same depth in one maximum coding unit, it is determined whether to split each of the coding units corresponding to the same depth to a lower depth by measuring an encoding error of the image data of each coding unit, separately. Accordingly, even when image data is included in one maximum coding unit, the image data is split into regions according to the depths, and the encoding errors may differ according to regions in the one maximum coding unit, and thus the coded depths may differ according to regions in the image data. Thus, one or more coded depths may be determined in one maximum coding unit, and the image data of the maximum coding unit may be divided according to coding units of at least one coded depth.

Accordingly, the hierarchical encoder 110 according to an exemplary embodiment may determine coding units having a tree structure included in the maximum coding unit. The ‘coding units having a tree structure’ according to an exemplary embodiment include coding units corresponding to a depth determined to be the coded depth, from among all deeper coding units included in the maximum coding unit. A coding unit having a coded depth may be hierarchically determined according to depths in the same region of the maximum coding unit, and may be independently determined in different regions. Similarly, a coded depth in a current region may be independently determined from a coded depth in another region.

A maximum depth according to an exemplary embodiment is an index related to the number of times splitting is performed from a maximum coding unit to a minimum coding unit. A first maximum depth according to an exemplary embodiment may denote the total number of times splitting is performed from the maximum coding unit to the minimum coding unit. A second maximum depth according to an exemplary embodiment may denote the total number of depth levels from the maximum coding unit to the minimum coding unit. For example, when a depth of the maximum coding unit is 0, a depth of a coding unit, in which the maximum coding unit is split once, may be set to 1, and a depth of a coding unit, in which the maximum coding unit is split twice, may be set to 2. Here, if the minimum coding unit is a coding unit in which the maximum coding unit is split four times, five depth levels of depths 0, 1, 2, 3, and 4 exist, and thus the first maximum depth may be set to 4, and the second maximum depth may be set to 5.

Prediction encoding and transformation may be performed according to the maximum coding unit. The prediction encoding and the transformation are also performed based on the deeper coding units according to a depth equal to or depths less than the maximum depth, according to the maximum coding unit.

Since the number of deeper coding units increases whenever the maximum coding unit is split according to depths, encoding including the prediction encoding and the transformation is performed on all of the deeper coding units generated as the depth deepens. For convenience of description, the prediction encoding and the transformation will now be described based on a coding unit of a current depth, in a maximum coding unit.

The video encoding apparatus 100 according to an exemplary embodiment may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the maximum coding unit, the prediction encoding may be performed based on a coding unit corresponding to a coded depth according to an exemplary embodiment, i.e., based on a coding unit that is no longer split into coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit or a data unit obtained by splitting at least one of a height and a width of the prediction unit.

For example, when a coding unit of 2N×2N (where N is a positive integer) is no longer split and becomes a prediction unit of 2N×2N, a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, an inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having the least encoding error.

Also, the video encoding apparatus 100 according to an exemplary embodiment may also perform the transformation on the image data in a coding unit based not only on the coding unit for encoding the image data, but also based on a data unit that is different from the coding unit.

In order to perform the transformation in the coding unit, the transformation may be performed based on a data unit having a size smaller than or equal to the coding unit. For example, the data unit for the transformation may include a data unit for an intra mode and a data unit for an inter mode.

A data unit used as a base of the transformation will now be referred to as a ‘transformation unit’. Similarly to the coding unit, the transformation unit in the coding unit may be recursively split into smaller sized regions, so that the transformation unit may be determined independently in units of regions. Thus, residual data in the coding unit may be divided according to the transformation unit having the tree structure according to transformation depths.

A transformation depth indicating the number of times splitting is performed to reach the transformation unit by splitting the height and width of the coding unit may also be set in the transformation unit. For example, in a current coding unit of 2N×2N, a transformation depth may be 0 when the size of a transformation unit is 2N×2N, may be 1 when the size of a transformation unit is NXN, and may be 2 when the size of a transformation unit is N/2×N/2. That is, the transformation unit having the tree structure may also be set according to transformation depths.

Encoding information according to coding units corresponding to a coded depth requires not only information about the coded depth, but also about information related to prediction encoding and transformation. Accordingly, the hierarchical encoder 110 not only determines a coded depth having the least encoding error, but also determines a partition type in a prediction unit, a prediction mode according to prediction units, and a size of a transformation unit for transformation.

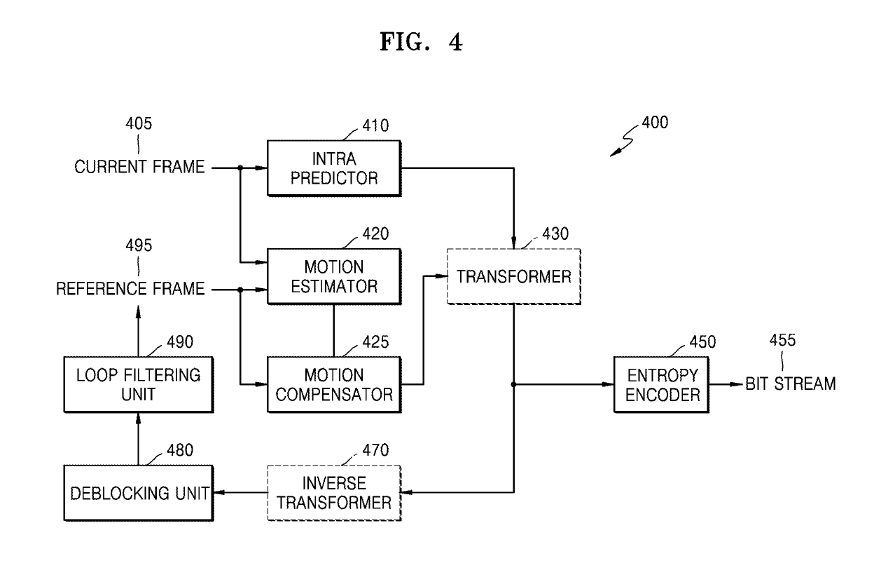

Coding units having a tree structure in a maximum coding unit and a method of determining a partition, according to an exemplary embodiment, will be described in detail later with reference to FIGS. 3 through 12.

The hierarchical encoder 110 may measure an encoding error of deeper coding units according to depths by using Rate-Distortion Optimization based on Lagrangian multipliers.

The entropy encoder 120 outputs the image data of the maximum coding unit, which is encoded based on the at least one coded depth determined by the hierarchical encoder 110, and information about the encoding mode according to the coded depth, in bit streams. The encoded image data may be a coding result of residual data of an image and includes information about transformation coefficients. The information about the encoding mode according to the coded depth may include information about the coded depth, information about the partition type in the prediction unit, prediction mode information, and size information of the transformation unit. In particular, as will be described later, the entropy encoder 120 according to an exemplary embodiment may entropy encode a transformation unit significant coefficient flag (coded_block_flag; cbf) indicating whether a transformation coefficient that is not 0 is included in a transformation unit, by using a context model determined based on a transformation depth of the transformation unit. The operation of entropy encoding syntax elements related to a transformation unit, performed by the entropy encoder 120, will be described later.

The information about the coded depth may be defined by using split information according to depths, which indicates whether encoding is performed on coding units of a lower depth instead of a current depth. If the current depth of the current coding unit is the coded depth, image data in the current coding unit is encoded and output, and thus the split information may be defined not to split the current coding unit to a lower depth. Alternatively, if the current depth of the current coding unit is not the coded depth, the encoding is performed on the coding unit of the lower depth, and thus the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one maximum coding unit, and information about at least one encoding mode is determined for a coding unit of a coded depth, information about at least one encoding mode may be determined for one maximum coding unit. Also, a coded depth of the image data of the maximum coding unit may be different according to locations since the image data is hierarchically split according to depths, and thus information about the coded depth and the encoding mode may be set for the image data.

Accordingly, the entropy encoder 120 according to an exemplary embodiment may assign encoding information about a corresponding coded depth and an encoding mode to at least one of the coding unit, the prediction unit, and a minimum unit included in the maximum coding unit.

The minimum unit according to an exemplary embodiment is a square-shaped data unit obtained by splitting the minimum coding unit constituting the lowermost depth by 4. Alternatively, the minimum unit may be a maximum square-shaped data unit that may be included in all of the coding units, prediction units, partition units, and transformation units included in the maximum coding unit.

For example, the encoding information output through the entropy encoder 120 may be classified into encoding information according to coding units and encoding information according to prediction units. The encoding information according to the coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode. Also, information about a maximum size of the coding unit defined according to pictures, slices, or GOPs, and information about a maximum depth may be inserted into a header of a bit stream.

In the video encoding apparatus 100 according to a simplest exemplary embodiment, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit of the current depth having the size of 2N×2N may include a maximum number of four coding units of the lower depth.

Accordingly, the video encoding apparatus 100 may form the coding units having the tree structure by determining coding units having an optimum shape and an optimum size for each maximum coding unit, based on the size of the maximum coding unit and the maximum depth determined considering characteristics of the current picture. Also, since encoding may be performed on each maximum coding unit by using any one of various prediction modes and transformations, an optimum encoding mode may be determined considering image characteristics of the coding unit of various image sizes.

Thus, if an image having a high resolution or a large data amount is encoded in a conventional macroblock, a number of macroblocks per picture excessively increases. Accordingly, a number of pieces of compressed information generated for each macroblock increases, and thus it is difficult to transmit the compressed information and data compression efficiency decreases. However, by using the video encoding apparatus 100 according to an exemplary embodiment, image compression efficiency may be increased since a coding unit is adjusted while considering characteristics of an image while increasing a maximum size of a coding unit while considering a size of the image.

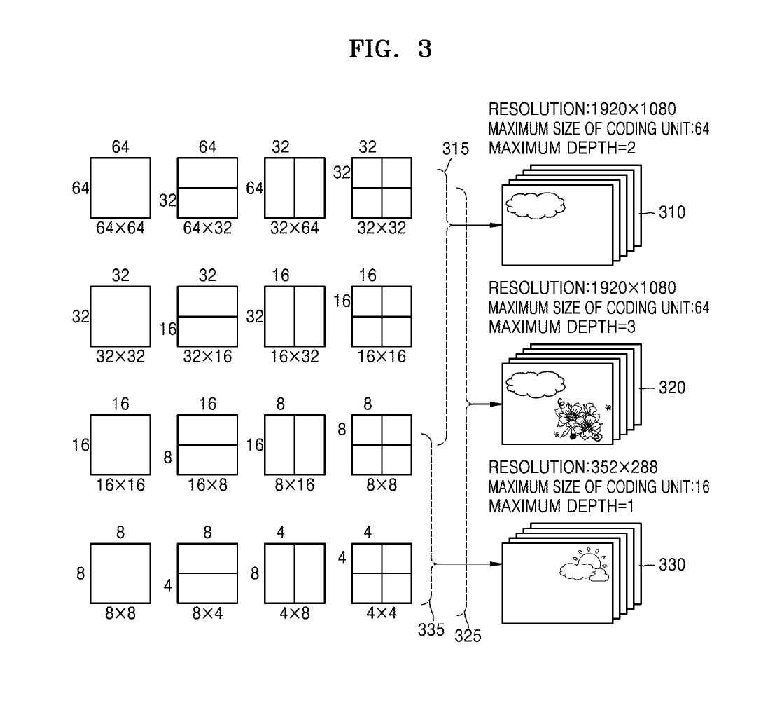

FIG. 2 is a block diagram of a video decoding apparatus 200 according to an exemplary embodiment.

The video decoding apparatus 200 according to an exemplary embodiment includes a parser 210, an entropy decoder 220, and a hierarchical decoder 230. Definitions of various terms, such as a coding unit, a depth, a prediction unit, a transformation unit, and information about various encoding modes, for various operations of the video decoding apparatus 200 according to an exemplary embodiment are identical to those described with reference to FIG. 1 and the video encoding apparatus 100.

The parser 210 receives a bit stream of an encoded video so as to parse a syntax element. The entropy decoder 220 performs entropy decoding on the parsed syntax elements to thereby arithmetically decode a syntax element indicating encoded image data based on coding units having a tree structure, and outputs the arithmetically decoded syntax element to the hierarchical decoder 230. That is, the entropy decoder 220 performs entropy decoding on the syntax elements received as a bit stream comprising 0s or 1s to reconstruct the syntax element.

The entropy decoder 220 extracts additional information about a coded depth, an encoding mode, color component information, prediction mode information, etc. for the coding units having a tree structure according to each maximum coding unit. The extracted information about the coded depth and the encoding mode is output to the hierarchical decoder 230. The image data in a bit stream is encoded after being split into the maximum coding unit so that the hierarchical decoder 230 may decode the image data for each maximum coding unit.

The information about the coded depth and the encoding mode according to the maximum coding unit may be set for information about at least one coding unit corresponding to the coded depth, and information about an encoding mode may include information about a partition type of a corresponding coding unit corresponding to the coded depth, about a prediction mode, and a size of a transformation unit. Also, splitting information according to depths may be extracted as the information about the coded depth.

The information about the coded depth and the encoding mode according to each maximum coding unit extracted by the entropy decoder 220 is information about a coded depth and an encoding mode determined to generate a minimum encoding error when an encoder, such as the video encoding apparatus 100 according to an exemplary embodiment, repeatedly performs encoding for each deeper coding unit according to depths according to each maximum coding unit. Accordingly, the video decoding apparatus 200 may reconstruct an image by decoding the image data according to a coded depth and an encoding mode that generates the minimum encoding error.

Since encoding information about the coded depth and the encoding mode according to an exemplary embodiment may be assigned to a predetermined data unit from among a corresponding coding unit, a prediction unit, and a minimum unit, the entropy decoder 220 may extract the information about the coded depth and the encoding mode according to the predetermined data units. The predetermined data units to which the same information about the coded depth and the encoding mode is assigned may be inferred to be the data units included in the same maximum coding unit.

The hierarchical decoder 230 reconstructs the current picture by decoding the image data in each maximum coding unit based on the information about the coded depth and the encoding mode according to the maximum coding units. In other words, the hierarchical decoder 230 may decode the encoded image data based on the extracted information about the partition type, the prediction mode, and the transformation unit for each coding unit from among the coding units having the tree structure included in each maximum coding unit. A decoding process may include prediction including intra prediction and motion compensation, and inverse transformation.

The hierarchical decoder 230 may perform intra prediction or motion compensation according to a partition and a prediction mode of each coding unit, based on the information about the partition type and the prediction mode of the prediction unit of the coding unit according to coded depths.

Also, the hierarchical decoder 230 may perform inverse transformation according to each transformation unit in the coding unit, based on the information about the size of the transformation unit of the coding unit according to coded depths, so as to perform the inverse transformation according to maximum coding units.

The hierarchical decoder 230 may determine at least one coded depth of a current maximum coding unit by using split information according to depths. If the split information indicates that image data is no longer split in the current depth, the current depth is a coded depth. Accordingly, the hierarchical decoder 230 may decode the coding unit of the current depth with respect to the image data of the current maximum coding unit by using the information about the partition type of the prediction unit, the prediction mode, and the size of the transformation unit.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the hierarchical decoder 230 in the same encoding mode.

The video decoding apparatus 200 according to an exemplary embodiment may obtain information about at least one coding unit that generates the minimum encoding error when encoding is recursively performed for each maximum coding unit, and may use the information to decode the current picture. In other words, encoded image data of the coding units having the tree structure determined to be the optimum coding units in each maximum coding unit may be decoded.

Accordingly, even if image data has a high resolution and an excessively large amount of data, the image data may be efficiently decoded and reconstructed by using a size of a coding unit and an encoding mode, which are adaptively determined according to characteristics of the image, by using information about an optimum encoding mode received from an encoder end.

A method of determining coding units having a tree structure, a prediction unit, and a transformation unit, according to an exemplary embodiment, will now be described with reference to FIGS. 3 through 13.

FIG. 3 is a diagram for describing a concept of coding units.

A size of a coding unit may be expressed in width×height, and may be 64×64, 32×32, 16×16, and 8×8. A coding unit of 64×64 may be split into partitions of 64×64, 64×32, 32×64, or 32×32; and a coding unit of 32×32 may be split into partitions of 32×32, 32×16, 16×32, or 16×16; a coding unit of 16×16 may be split into partitions of 16×16, 16×8, 8×16, or 8×8; and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 3 denotes a total number of splits from a maximum coding unit to a minimum coding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having the higher resolution than the video data 330 may be 64.

Since the maximum depth of the video data 310 is 2, coding units 315 of the vide data 310 may include a maximum coding unit having a long axis size of 64, and coding units having long axis sizes of 32 and 16 since depths are deepened to two layers by splitting the maximum coding unit twice. Meanwhile, since the maximum depth of the video data 330 is 1, coding units 335 of the video data 330 may include a maximum coding unit having a long axis size of 16, and coding units having a long axis size of 8 since depths are deepened to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8 since the depths are deepened to 3 layers by splitting the maximum coding unit three times. As a depth deepens, detailed information may be precisely expressed.

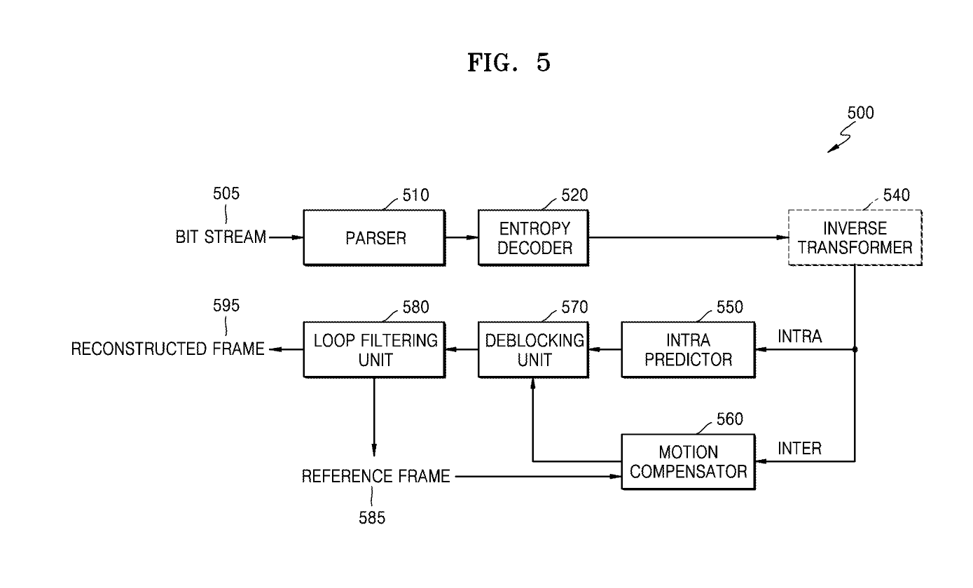

FIG. 4 is a detailed block diagram of a video encoding apparatus 400 based on coding units having a hierarchical structure, according to an exemplary embodiment.

An intra predictor 410 performs intra prediction on coding units in an intra mode, with respect to a current frame 405, and a motion estimator 420 and a motion compensator 425 respectively perform inter estimation and motion compensation on coding units in an inter mode by using the current frame 405 and a reference frame 495.

Data output from the intra predictor 410, the motion estimator 420, and the motion compensator 425 passes through a transformer 430 to be output as a transformation coefficient. A typical video decoding apparatus further undergoes a process in which data that has passed through the transformer 430 is quantized, whereas, in the video encoding apparatus 400 according to an exemplary embodiment, in order to perform lossless coding, quantization and inverse quantization are bypassed to prevent data loss due to quantization.

The transformation coefficient is reconstructed to data in a spatial domain through an inverse transformer 470, and the reconstructed data in a spatial domain may be output as a bit stream 455 after being post-processed through a deblocking unit 480 and a loop filtering unit 490. Meanwhile, as another example, in the video encoding apparatus 400 according to an exemplary embodiment, for lossless coding, an operation of at least one of the transformer 430, the deblocking unit 480, and the loop filtering unit 490 may be further bypassed. For example, if both transformation and quantization are bypassed (that is, if the transformer 430 and the inverse transformer 470 are also omitted from the video encoding apparatus 400 of FIG. 4), residual data itself may be entropy encoded and decoded instead of the transformation coefficient described above. Here, as a method of encoding and decoding residual data, the method of encoding and decoding a transformation coefficient described above may be applied. That is, in an exemplary embodiment below in which both transformation and quantization are bypassed and residual data itself is entropy encoded and decoded for lossless coding, the entropy encoder 450 may regard and process residual data as transformation data. Also, in an exemplary embodiment in which transformation is bypassed for lossless coding, a transformation unit described in the present specification may be regarded as a coding unit. That is, it will be obvious to one of ordinary skill in the art below that an operation performed on a transformation coefficient, described in the present specification, may also be performed by regarding residual data as a transformation coefficient.

The entropy encoder 450 according to an exemplary embodiment arithmetically encodes syntax elements related to a transformation unit such as a sub block flag (coded_sub_block_flag) indicating whether all transformation coefficients of a sub-block are 0, a significance map indicating a position of a transformation coefficient that is not 0, a first critical value flag (coeff_abs_level_greater1_flag) indicating whether a transformation coefficient is greater than 1, a second critical value flag (coeff_abs_level_greather2_flag) indicating whether a transformation coefficient is greater than 2, size information of a transformation coefficient (coeff_abs_level_remaining) corresponding to a difference between a base level (baseLevel) determined based on the first critical value flag and the second critical value flag and an actual transformation coefficient (abscoeff) or position information (last_significant_coeff_x, last_significant_coeff_y) indicating a last position of a transformation coefficient that is not 0 in a transformation unit, and outputs a bit stream.

In order for the video encoder 400 to be applied in the video encoding apparatus 100 according to an exemplary embodiment, all elements of the video encoder 400, i.e., the intra predictor 410, the motion estimator 420, the motion compensator 425, the transformer 430, the entropy encoder 450, the inverse transformer 470, the deblocking unit 480, and the loop filtering unit 490, perform operations based on each coding unit from among coding units having a tree structure while considering the maximum depth of each maximum coding unit.

The intra predictor 410, the motion estimator 420, and the motion compensator 425 determine partitions and a prediction mode of each coding unit from among the coding units having a tree structure while considering the maximum size and the maximum depth of a current maximum coding unit, and the transformer 430 determines the size of the transformation unit in each coding unit from among the coding units having a tree structure.

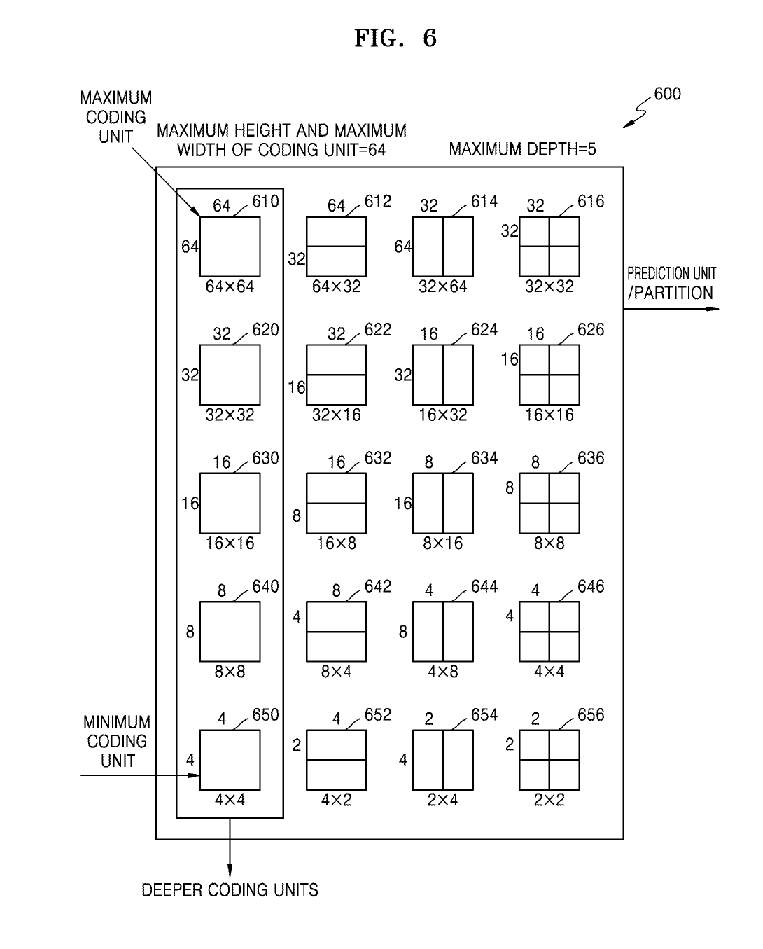

FIG. 5 is a detailed block diagram of a video decoding apparatus based on coding units having a hierarchical structure, according to an exemplary embodiment.

As a bit stream 505 passes through a parser 510, encoded image data which is an object to be decoded and syntax elements which are information about encoding needed for decoding are parsed. The encoded image data passes through the entropy encoder 520 to be output as decoded data. A typical video decoding apparatus further undergoes a process in which data that has passed through the entropy decoder 520 is inversely quantized, whereas, the video decoding apparatus 500 according to an exemplary embodiment receives non-quantized data in order to perform loss coding, and thus inverse quantization is bypassed. Alternatively, both inverse transformation and inverse quantization may be bypassed. The entropy decoder 520 according to an exemplary embodiment obtains syntax elements related to a transformation unit from a bit stream, such as a sub block flag (coded_sub_block_flag) indicating whether all transformation coefficients of a sub-block are 0, a significance map indicating a position of a transformation coefficient that is not 0, a first critical value flag (coeff_abs_level_greater1_flag) indicating whether a transformation coefficient is greater than 1, a second critical value flag (coeff_abs_level_greather2_flag) indicating whether a transformation coefficient is greater than 2, size information of a transformation coefficient (coeff_abs_level_remaining) corresponding to a difference between a base level (baseLevel) determined based on the first critical value flag and the second critical value flag and an actual transformation coefficient (abscoeff) or position information (last_significant_coeff_x, last_significant_coeff_y) indicating a last position of a transformation coefficient that is not 0 in a transformation unit, arithmetically decodes the obtained syntax elements to thereby reconstruct the syntax elements.

The inverse transformer 540 reconstructs the decoded data to image data of a spatial domain. Meanwhile, if transformation is bypassed for lossless coding, an inverse transformer 540 may be omitted in the video decoding apparatus 500 of FIG. 5. Also, in this case, the transformation unit and the transformation coefficient described above or a transformation unit and a transformation coefficient to be described later may be understood as a coding unit and residual data, respectively. An intra predictor 550 performs intra prediction on image data of a spatial domain with respect to a coding unit of an intra mode, and a motion compensator 560 performs motion compensation on a coding unit of an inter mode by using also a reference frame 585.

The image data in the spatial domain, which has passed through the intra predictor 550 and the motion compensator 560, may be output as a reconstruction frame 595 after being post-processed through a deblocking unit 570 and a loop filtering unit 580. Also, the data, which is post-processed through the deblocking unit 570 and the loop filtering unit 580, may be output as the reference frame 585.

In order for the video decoder 500 to be applied in the video decoding apparatus 200 according to an exemplary embodiment, all elements of the video decoder 500, i.e., the parser 510, the entropy decoder 520, the inverse transformer 540, the intra predictor 550, the motion compensator 560, the deblocking unit 570, and the loop filtering unit 580, perform operations based on coding units having a tree structure for each maximum coding unit.

The intra predictor 550 and the motion compensator 560 determine partitions and a prediction mode for each coding unit having a tree structure, and the inverse transformer 540 has to determine a size of a transformation unit for each coding unit.

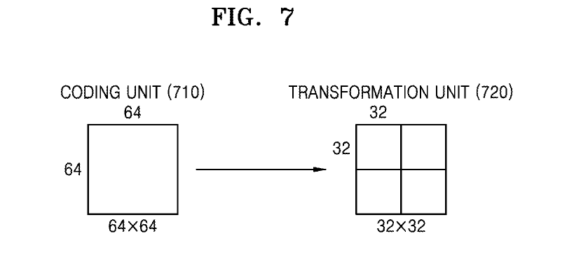

FIG. 6 is a diagram illustrating deeper coding units according to depths, and partitions, according to an exemplary embodiment.

The video encoding apparatus 100 and the video decoding apparatus 200 according to an exemplary embodiment use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units according to an exemplary embodiment, the maximum height and the maximum width of the coding units are each 64, and the maximum depth is 4. Since a depth deepens along a vertical axis of the hierarchical structure 600 according to an exemplary embodiment, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a maximum coding unit in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, a coding unit 640 having a size of 8×8 and a depth of 3, and a coding unit 650 having a size of 4×4 and a depth of 4 exist. The coding unit 650 having the size of 4×4 and the depth of 4 is a minimum coding unit.

The prediction unit and the partitions of a coding unit are arranged along the horizontal axis according to each depth. In other words, if the coding unit 610 having the size of 64×64 and the depth of 0 is a prediction unit, the prediction unit may be split into partitions included in the encoding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

The coding unit 650 having the size of 4×4 and the depth of 4 is the minimum coding unit and a coding unit of the lowermost depth. A prediction unit of the coding unit 650 is only assigned to a partition having a size of 4×4.

In order to determine the at least one coded depth of the coding units constituting the maximum coding unit 610, the hierarchical encoder 110 of the video encoding apparatus 100 performs encoding for coding units corresponding to each depth included in the maximum coding unit 610.

The number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths and performing encoding for each depth as the depth deepens along the vertical axis of the hierarchical structure 600. A depth and a partition having the minimum encoding error in the coding unit 610 may be selected as the coded depth and a partition type of the coding unit 610.

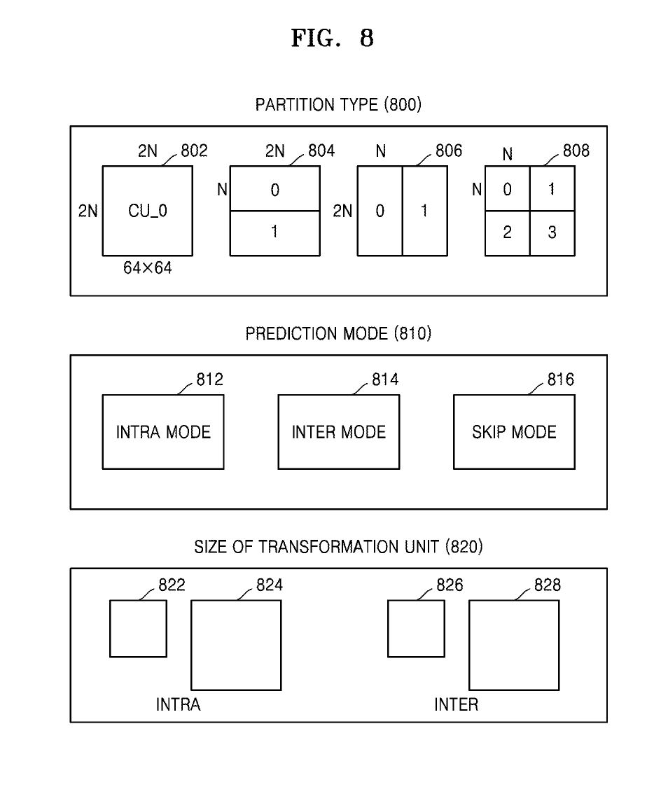

FIG. 7 is a diagram for describing a relationship between a coding unit 710 and transformation units 720, according to an exemplary embodiment of the inventive concept.

The video encoding apparatus 100 or the video decoding apparatus 200 according to an exemplary embodiment encodes or decodes an image according to coding units having sizes smaller than or equal to a maximum coding unit for each maximum coding unit. Sizes of transformation units for transformation during encoding may be selected based on data units that are not larger than a corresponding coding unit.

For example, in the video encoding apparatus 100 or the video decoding apparatus 200 according to an exemplary embodiment, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

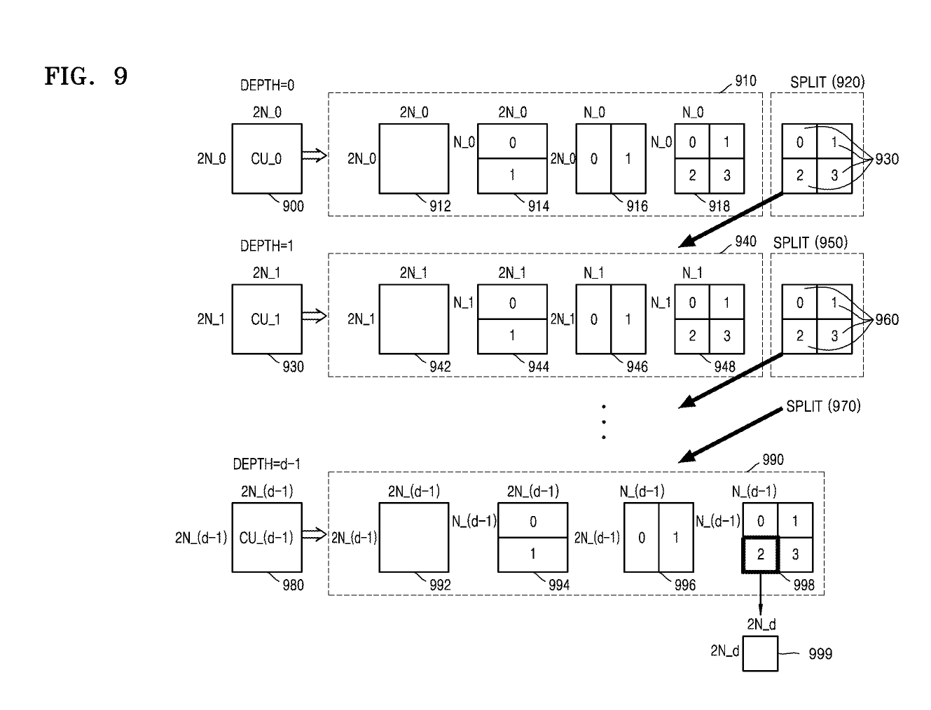

FIG. 8 is a diagram for describing encoding information of coding units corresponding to a coded depth, according to an exemplary embodiment of the inventive concept.

An output unit 130 of the video encoding apparatus 100 according to an exemplary embodiment may encode and transmit information 800 about a partition type, information 810 about a prediction mode, and information 820 about a size of a transformation unit for each coding unit corresponding to a coded depth, as information about an encoding mode.

The information 800 indicates information about a shape of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type is set to indicate one of the partition 804 having a size of 2N×N, the partition 806 having a size of N×2N, and the partition 808 having a size of N×N

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be one of a first intra transformation unit 822, a second intra transformation unit 824, a first inter transformation unit 826, and a second inter transformation unit 828.

The image data and encoding information extractor 210 of the video decoding apparatus 200 according to an exemplary embodiment may extract and use the information 800, 810, and 820 for decoding, according to each deeper coding unit.

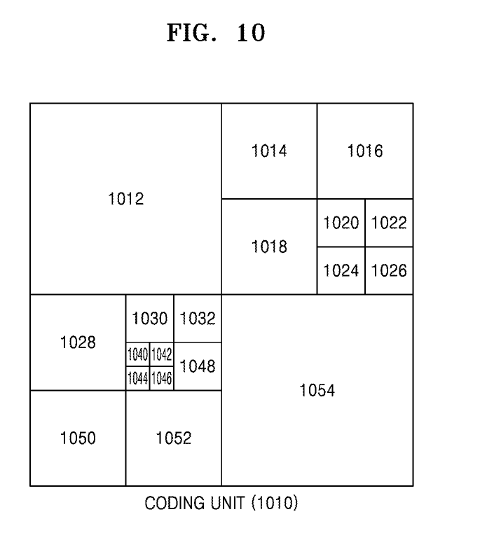

FIG. 9 is a diagram of deeper coding units according to depths, according to an exemplary embodiment.

Split information may be used to indicate a change of a depth. The spilt information indicates whether a coding unit of a current depth is split into coding units of a lower depth.

A prediction unit 910 for prediction encoding of a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 9 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode is performed only on the partition having the size of 2N_{—}0×2N_{—}0.

If an encoding error is the smallest in one of the partition types 912 through 916 having the sizes of 2N_{—}0×2N_{—}0, 2N_{—}0×N_{—}0, and N_{—}0×2N_{—}0, the prediction unit 910 may not be split into a lower depth.

If the encoding error is the smallest in the partition type 918 having the size of N_{—}0×N_{—}0, a depth is changed from 0 to 1 to split the partition type 918 in operation 920, and encoding is repeatedly performed on partition type coding units having a depth of 2 and a size of N_{—}0×N_{—}0 to search for a minimum encoding error.

A prediction unit 940 for prediction encoding of the (partition type) coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948 having the size of N_{—}1×N_{—}1, a depth is changed from 1 to 2 to split the partition type 948 in operation 950, and encoding is repeatedly performed on coding units 960, which have a depth of 2 and a size of N_{—}2×N_{—}2 to search for a minimum encoding error.

When a maximum depth is d, a split operation according to each depth may be performed up to when a depth becomes d−1, and split information may be encoded as up to when a depth is one of 0 to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition type 992 having a size of 2N_(d−1)×2N_(d−1), a partition type 994 having a size of 2N_(d−1)×N_(d−1), a partition type 996 having a size of N_(d−1)×2N_(d−1), and a partition type 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition types 992 through 998 to search for a partition type having a minimum encoding error.

Even when the partition type 998 having the size of N_(d−1)×N_(d−1) has the minimum encoding error, since a maximum depth is d, a coding unit CU_(d−1) having a depth of d−1 is no longer split to a lower depth, and a coded depth for the coding units constituting the current maximum coding unit 900 is determined to be d−1 and a partition type of the current maximum coding unit 900 may be determined to be N_(d−1)×N_(d−1). Also, since the maximum depth is d, split information for the minimum coding unit 952 is not set.

A data unit 999 may be a ‘minimum unit’ for the current maximum coding unit. A minimum unit according to an exemplary embodiment may be a rectangular data unit obtained by splitting the minimum coding unit 980 by 4. By performing the encoding repeatedly, the video encoding apparatus 100 may select a depth having the least encoding error by comparing encoding errors according to depths of the coding unit 900 to determine a coded depth, and set a corresponding partition type and a prediction mode as an encoding mode of the coded depth.

As such, the minimum encoding errors according to depths are compared in all of the depths of 1 through d, and a depth having the least encoding error may be determined as a coded depth. The coded depth, the partition type of the prediction unit, and the prediction mode may be encoded and transmitted as information about an encoding mode. Also, since a coding unit is split from a depth of 0 to a coded depth, only split information of the coded depth is set to 0, and split information of depths excluding the coded depth is set to 1.

The image data and encoding information extractor 220 of the video decoding apparatus 200 according to an exemplary embodiment may extract and use the information about the coded depth and the prediction unit of the coding unit 900 to decode the coding unit 912. The video decoding apparatus 200 according to an exemplary embodiment may determine a depth, in which split information is 0, as a coded depth by using split information according to depths, and use information about an encoding mode of the corresponding depth for decoding.

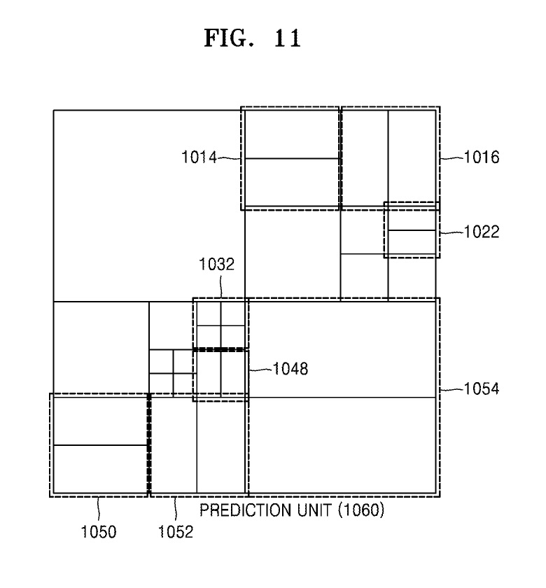

FIGS. 10 through 12 are diagrams for describing a relationship between coding units, prediction units, and transformation units according to an exemplary embodiment of the inventive concept.

The coding units 1010 are coding units having a tree structure, corresponding to coded depths determined by the video encoding apparatus 100, in a maximum coding unit. The prediction units 1060 are partitions of prediction units of each of the coding units 1010, and the transformation units 1070 are transformation units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some coding units 1014, 1016, 1022, 1032, 1048, 1050, 1052, and 1054 are obtained by splitting the coding units. In other words, partition types in the coding units 1014, 1022, 1050, and 1054 have a size of 2N×N, partition types in the coding units 1016, 1048, and 1052 have a size of N×2N, and a partition type of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, 1052, and 1054 in the transformation units 1070 are different from those in the prediction units 1060 in terms of sizes and shapes. In other words, the video encoding apparatus 100 and the video decoding apparatus 200 may perform intra prediction, motion estimation, motion compensation, transformation, and inverse transformation individually on a data unit in the same coding unit.

Accordingly, encoding is recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transformation unit. Table 1 shows the encoding information that may be set by the video encoding apparatus 100 and the video decoding apparatus 200.

TABLE 1

| Split Information 0 | | | | | |
|---|---|---|---|---|---|
| (Encoding on Coding Unit having Size of 2N × 2N and Current Depth of d) | | | | | |
| | | | Size of Transformation Unit | | |
| | | | Split | Split | |
| | Partition Type | | Information 0 | Information 1 | |
| | Symmetrical | Asymmetrical | of | of | Split |
| Prediction | Partition | Partition | Transformation | Transformation | Information |
| Mode | Type | Type | Unit | Unit | 1 |
| Intra | 2N × 2N | 2N × nU | 2N × 2N | N × N | Repeatedly |
| Inter | 2N × N | 2N × nD | | (Symmetrical | Encode |
| Skip | N × 2N | nL × 2N | | Type) | Coding |
| (Only | N × N | nR × 2N | | N/2 × N/2 | Units |
| 2N × 2N) | | | | (Asymmetrical | having |
| | | | | Type) | Lower |
| | | | | | Depth of |
| | | | | | d + 1 |

The entropy encoder 120 of the video encoding apparatus 100 according to an exemplary embodiment may output the encoding information about the coding units having a tree structure, and the entropy decoder 220 of the video decoding apparatus 200 according to an exemplary embodiment may extract the encoding information about the coding units having a tree structure from a received bit stream.

Split information indicates whether a current coding unit is split into coding units of a lower depth. If split information of a current depth d is 0, a depth, in which a current coding unit is no longer split into a lower depth, is a coded depth, and thus information about a partition type, a prediction mode, and a size of a transformation unit may be defined for the coded depth. If the current coding unit is further split according to the split information, encoding is independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:n and n:1 (where n is an integer greater than 1), and the asymmetrical partition types having the sizes of nL×2N and nR×2N may be respectively obtained by splitting the width of the prediction unit in 1:n and n:1.

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure according to an exemplary embodiment may include at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth is determined by using encoding information of a data unit, and thus a distribution of coded depths in a maximum coding unit may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred to for predicting the current coding unit.

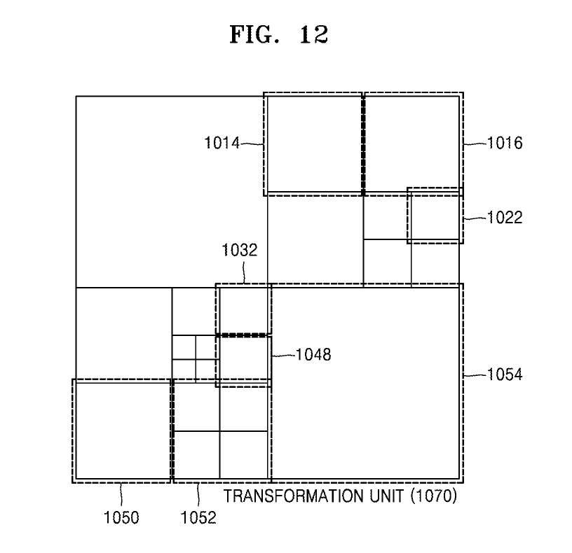

FIG. 13 is a diagram for describing a relationship between a coding unit, a prediction unit, and a transformation unit according to the encoding mode information of Table 1.

A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

When the partition type is set to be symmetrical, i.e. the partition type 1322, 1324, 1326, or 1328, a transformation unit 1342 having a size of 2N×2N is set if split information (TU size flag) of a transformation unit is 0, and a transformation unit 1344 having a size of N×N is set if a TU size flag is 1.

When the partition type is set to be asymmetrical, i.e., the partition type 1332, 1334, 1336, or 1338, a transformation unit 1352 having a size of 2N×2N is set if a TU size flag is 0, and a transformation unit 1354 having a size of N/2×N/2 is set if a TU size flag is 1.

The TU size flag is a type of transformation index; a size of a transformation unit corresponding to a transformation index may be modified according to a prediction unit type or a partition type of a coding unit.

When the partition type is set to be symmetrical, i.e. the partition type 1322, 1324, 1326, or 1328, the transformation unit 1342 having a size of 2N×2N is set if a TU size flag of a transformation unit is 0, and the transformation unit 1344 having a size of N×N is set if a TU size flag is 1.

When the partition type is set to be asymmetrical, i.e., the partition type 1332 (2N×nU), 1334 (2N×nD), 1336 (nL×2N), or 1338 (nR×2N), the transformation unit 1352 having a size of 2N×2N is set if a TU size flag is 0, and the transformation unit 1354 having a size of N/2×N/2 is set if a TU size flag is 1.

Referring to FIG. 9, the TU size flag described above is a flag having a value of 0 or 1, but the TU size flag is not limited to 1 bit, and a transformation unit may be hierarchically split while the TU size flag increases from 0. The transformation unit split information (TU size flag) may be used as an example of a transformation index.

In this case, when a TU size flag according to an exemplary embodiment is used with a maximum size and a minimum size of a transformation unit, the size of the actually used transformation unit may be expressed. The video encoding apparatus 100 may encode maximum transformation unit size information, minimum transformation unit size information, and maximum transformation unit split information. The encoded maximum transformation unit size information, minimum transformation unit size information, and maximum transformation unit split information may be inserted into a sequence parameter set (SPS). The video decoding apparatus 200 according to an exemplary embodiment may use the maximum transformation unit size information, the minimum transformation unit size information, and the maximum transformation unit split information for video decoding.

For example, (a) if a size of a current coding unit is 64×64 and a maximum transformation unit is 32×32, (a−1) a size of a transformation unit is 32×32 if a TU size flag is 0; (a−2) a size of a transformation unit is 16×16 if a TU size flag is 1; and (a−3) a size of a transformation unit is 8×8 if a TU size flag is 2.

Alternatively, (b) if a size of a current coding unit is 32×32 and a minimum transformation unit is 32×32, (b−1) a size of a transformation unit is 32×32 if a TU size flag is 0, and since the size of a transformation unit cannot be smaller than 32×32, no more TU size flags may be set.

Alternatively, (c) if a size of a current encoding unit is 64×64 and a maximum TU size flag is 1, a TU size flag may be 0 or 1 and no other TU size flags may be set.

Accordingly, when defining a maximum TU size flag as ‘MaxTransformSizeIndex’, a minimum TU size flag as ‘MinTransformSize’, and a transformation unit in the case when a TU size flag is 0, that is, a basic transformation unit RootTu as ‘RootTuSize’, a size of a minimum transformation unit ‘CurrMinTuSize’, which is available in a current coding unit, may be defined by Equation (1) below.

CurrMinTuSize=max(MinTransformSize,RootTuSize/(2̂MaxTransformSizeIndex)) (1)

In comparison with the size of the minimum transformation unit ‘CurrMinTuSize’ that is available in the current coding unit, the basic transformation unit size ‘RootTuSize’, which is a size of a transformation unit when if a TU size flag is 0, may indicate a maximum transformation unit which may be selected in regard to a system. That is, according to Equation (1), ‘RootTuSize/(2̂MaxTransformSizeIndex)’ is a size of a transformation unit that is obtained by splitting ‘RootTuSize’, which is a size of a transformation unit when transformation unit split information is 0, by the number of splitting times corresponding to the maximum transformation unit split information, and ‘MinTransformSize’ is a size of a minimum transformation unit, and thus a smaller value of these may be ‘CurrMinTuSize’ which is the size of the minimum transformation unit that is available in the current coding unit.

The size of the basic transformation unit ‘RootTuSize’ according to an exemplary embodiment may vary according to a prediction mode.

For example, if a current prediction mode is an inter mode, RootTuSize may be determined according to Equation (2) below. In Equation (2), ‘MaxTransformSize’ refers to a maximum transformation unit size, and ‘PUSize’ refers to a current prediction unit size.

RootTuSize=min(MaxTransformSize,PUSize) (2)

In other words, if a current prediction mode is an inter mode, the size of the basic transformation unit size ‘RootTuSize’, which is a transformation unit if a TU size flag is 0, may be set to a smaller value from among the maximum transformation unit size and the current prediction unit size.

If a prediction mode of a current partition unit is an intra mode, ‘RootTuSize’ may be determined according to Equation (3) below. ‘PartitionSize’ refers to a size of the current partition unit.

RootTuSize=min(MaxTransformSize,PartitionSize) (3)

In other words, if a current prediction mode is an intra mode, the basic transformation unit size ‘RootTuSize’ may be set to a smaller value from among the maximum transformation unit size and the current partition unit size.

However, it should be noted that the size of the basic transformation unit size ‘RootTuSize’, which is the current maximum transformation unit size according to an exemplary embodiment and varies according to a prediction mode of a partition unit, is an example, and factors for determining the current maximum transformation unit size are not limited thereto.

Meanwhile, the video encoding apparatus 100 and the video decoding apparatus 200 according to an exemplary embodiment may perform lossless encoding and decoding, and as quantization is bypassed in lossless encoding and decoding, a transformation coefficient coding method of a context level that assumes quantization may cause inefficiency.

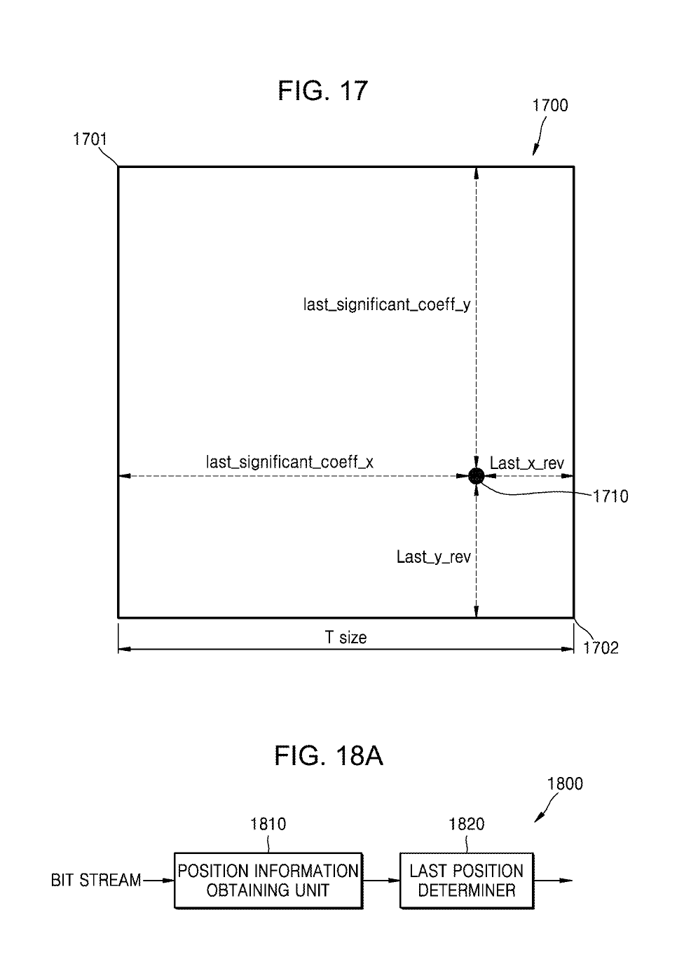

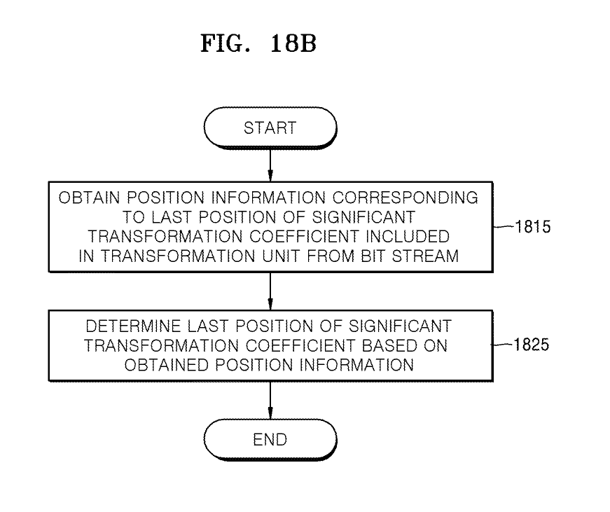

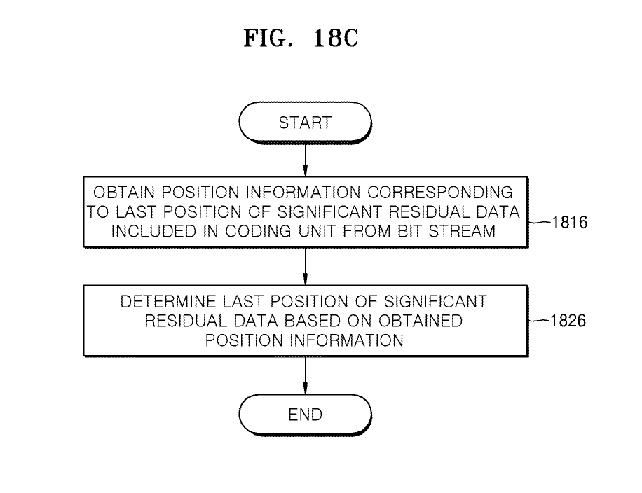

For example, when frequency transformation (for example, DCT (Discrete cosine transform)) is performed on spatial residual data, the spatial residual data has a very small value in a high frequency region, and thus most of the spatial residual data may be quantized to 0. Thus, compression efficiency may be increased by encoding just a significant transformation coefficient. However, since quantization is not performed in lossless encoding and decoding, more significant transformation coefficients, which are though of a small value, may exist also in a high frequency region. For example, a last position of a significant transformation coefficient may be close to a low frequency region of a transformation unit if quantization is performed. However, in lossless coding where quantization is not performed, a last position of a significant transformation coefficient may be close to a high frequency region. Thus, when a last position of a significant transformation coefficient is determined as a syntax element based on a distance in a low frequency region as in the related art, a value of the significant transformation coefficient is great. Thus, such problems are resolved by using methods described below with reference to FIGS. 14A and 18. Alternatively, if encoding is performed directly without frequency transformation, residual data may exist also at a position corresponding to a high frequency region, and thus, the probability that last position information is close to the high frequency region is even higher.

In addition, since quantization is not performed in lossless coding, it may be inefficient to encode and transmit predetermined syntax elements related to a transformation unit such as a sub block flag (coded_sub_block_flag) indicating whether all transformation coefficients of a sub-block are 0, a significance map indicating a position of a transformation coefficient that is not 0, a first critical value flag (coeff_abs_level_greater1_flag) indicating whether a transformation coefficient is greater than 1, a second critical value flag (coeff_abs_level_greather2_flag) indicating whether a transformation coefficient is greater than 2, or size information of a transformation coefficient (coeff_abs_level_remaining) corresponding to a difference between a base level (baseLevel) determined based on the first critical value flag and the second critical value flag and an actual transformation coefficient (abscoeff). Thus, the video encoding apparatus 100 and the video decoding apparatus 200 according to an exemplary embodiment may omit operations related to methods of obtaining, encoding, and transmitting syntax elements related to a transformation unit described above.

Hereinafter, a process of encoding a last position of a significant transformation coefficient performed by the entropy encoder 120 of the video encoding apparatus 100 of FIG. 1 and a process of decoding a last position of a significant transformation coefficient performed by the entropy decoder 220 of the video decoding apparatus 200 of FIG. 2 will be described in detail.

FIG. 14A is a block diagram illustrating an apparatus for encoding a last position of a significant transformation coefficient or significant residual data in lossless coding according to an exemplary embodiment.

In the apparatus for encoding a last position of a significant transformation coefficient or residual data illustrated in FIG. 14A (hereinafter, “last position encoding apparatus 1400”), only elements that are related to the present exemplary embodiment are illustrated. Thus, it will be obvious to one of ordinary skill in the art that other general-use elements may be further included in addition to the elements illustrated in FIG. 14A. The last position encoding apparatus 1400 corresponds to the entropy encoder 120 of the video encoding apparatus 100 of FIG. 1.

Referring to FIG. 14A, the last position encoding apparatus 1400 according to an exemplary embodiment may include a scanner 1410, a last position determiner 1420, and a position information determiner 1430, and an encoder 1440.

The scanner 1410 according to an exemplary embodiment may perform scanning in a predetermined order from a first point to a second point of a transformation unit to thereby obtain a transformation coefficient included in the transformation unit. The first point may be a low frequency position of the transformation unit, and the second point may be a high frequency position of the transformation unit. Thus, the first point may be an upper left corner of the transformation unit, and the second point may be a lower right corner of the transformation unit. In addition, the transformation unit may be residual data on which DCT (Discrete cosine transform) is performed.

The last position determiner 1420 according to an exemplary embodiment may determine a last position of a significant transformation coefficient that is not 0 from among coefficients included in a coding unit.

The position information determiner 1430 according to an exemplary embodiment may determine position information corresponding to the determined last position with respect to the second point. The position information may be a value corresponding to a distance from the second point to the determined last position. That is, the position information may be coordinate values corresponding to the determined last position with respect to the second point as the origin. Here, the position information may correspond to the above-described syntax elements.

The encoder 1440 according to an exemplary embodiment may encode the determined position information. To encode position information, entropy coding described above may be used.

Hereinafter, an operation of the last position encoding apparatus 1400 of FIG. 14A will be described in detail with reference to FIG. 14B.

FIG. 14B is a flowchart of a method of encoding a last position of a significant transformation coefficient in lossless coding according to an exemplary embodiment.

Referring to FIG. 14B,

in operation 1415, the scanner 1410 according to an exemplary embodiment may perform scanning from a first point to a second point of a transformation unit in a predetermined order to thereby obtain transformation coefficients included in the transformation unit. Here, the transformation unit may have the same size as that of a coding unit.

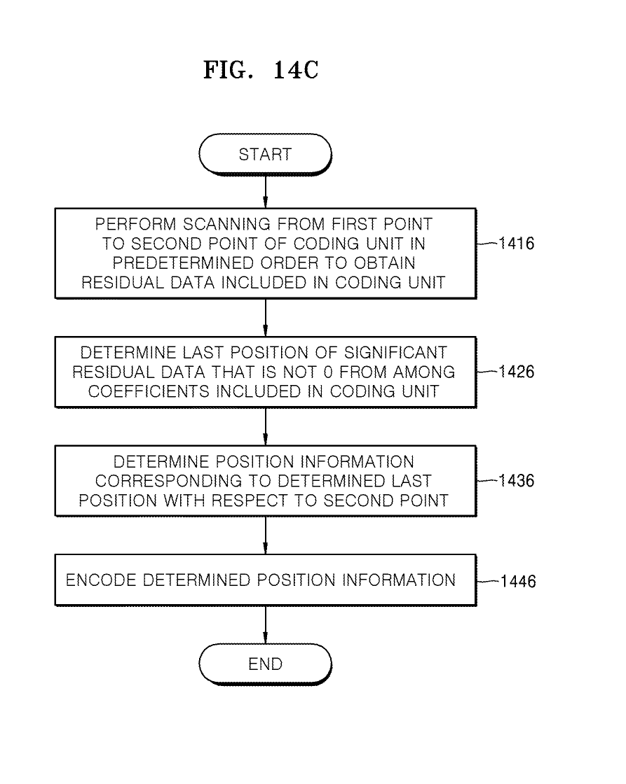

For example, FIG. 15 illustrates an example of obtaining a transformation coefficient included in a transformation unit. While FIG. 15 illustrates a transformation unit 1500 having a size of 16×16, a size of the transformation unit 2000 is not limited to the illustrated 16×16 but may be various such as 4×4 to 32×32.

Referring to FIG. 15, for entropy encoding and decoding of a transformation coefficient included in the transformation unit 1500, the transformation unit 1500 may be split into transformation units of a smaller size. First, the scanner 1410 according to an exemplary embodiment may perform scanning from a first point 1501 to a second point 1502 in an illustrated order (zigzag scanning) to thereby obtain a transformation coefficient included in the transformation unit 1500. While FIG. 15 illustrates an example where scanning is performed on a transformation unit 1501, scanning of transformation coefficients may also be performed for each transformation unit of a smaller size (for example, 4×4) in the order illustrated in FIG. 15.

Referring to FIG. 14B again, in operation 1425, the last position determiner 1420 according to an exemplary embodiment may determine a last position of a significant transformation coefficient that is not 0 from among coefficients included in the transformation unit. That is, all transformation coefficients behind the last position in a scanning order are 0. For example, 1510 may be the last position of the obtained significant transformation coefficient. When the last position is determined, the encoding apparatus 100 according to an exemplary embodiment may encode a transformation coefficient included in the transformation unit in a reverse order to the scanning order. Accordingly, encoding on transformation coefficients from the second position 1502 to the last position 1510 may be bypassed.

Meanwhile, according to the related art, position information of the last position is entropy encoded with respect to the first point 1501 without change. For example, if a position of a last significant transformation coefficient is (x,y) (where x and y are integers), last_significant_coeff_x 1511 and last_significant_coeff_y 1512, which are syntax elements which represent coordinate values of (x, y), may be entropy encoded and decoded.

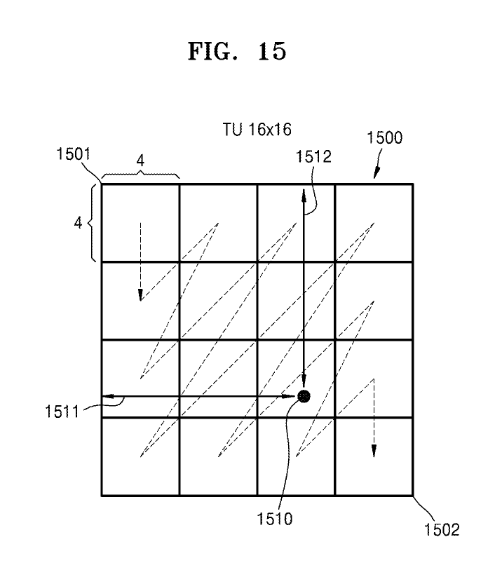

In addition, a bit as illustrated in table 1600 of FIG. 16 may be allocated to a syntax element at a last position that is entropy encoded.

Referring to FIG. 16, the higher is a value corresponding to a last position of a significant transformation coefficient, the greater is the number of bits allocated in accordance with context modeling, resulting in an increase in a binary value fixed for entropy encoding.

Since quantization is not performed in lossless encoding and decoding, more significant transformation coefficients, which may be though of a small value, may exist in a high frequency region (lower right end of FIG. 15). Thus, the probability that a last position of a significant transformation coefficient is close to the high frequency region 1502 (1510 of FIG. 15) is high. That is, a last position of a significant transformation coefficient may exist close to the low frequency region 1501 of the transformation unit when quantization is performed, but in lossless coding where quantization is not performed, the last position of the significant transformation coefficient may be close to the high frequency region 1502. Alternatively, if frequency transformation is not performed, there is the possibility that residual data that is not 0 exists at a position corresponding to the high frequency region, and thus, the last position may be close to the high frequency region.

However, since position information of a last position of a significant transformation coefficient is determined based on the low frequency region 1501 according to the related art as described above, a value of the last position is always large in lossless coding. That is, a length of bits required to encode the last position is increased.

Thus, in operation 1435, the position information determiner 1430 according to an exemplary embodiment may determine position information corresponding to the determined last position with respect to the second point 1502. In operation 1445, the encoder 1446 according to an exemplary embodiment may encode the determined position information.

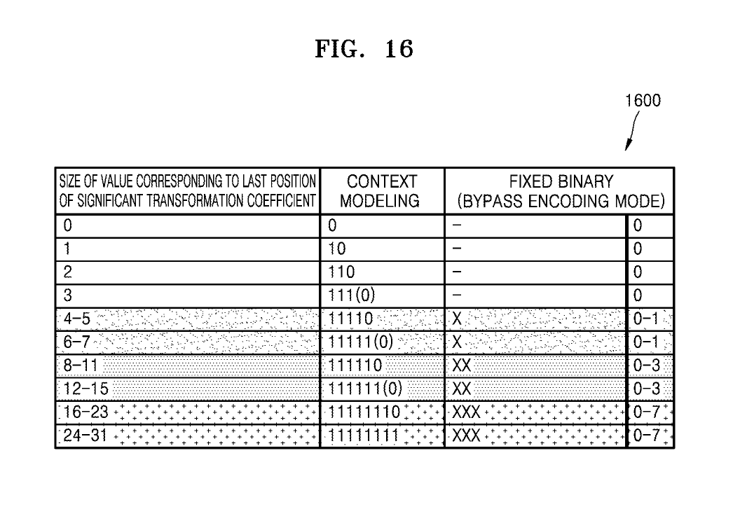

For example, FIG. 17 illustrates an example of determining a syntax element corresponding to a last position of a significant transformation coefficient according to an exemplary embodiment.

Referring to FIG. 17, Last_x_rev, Last_x_rev with respect to a second point 1702 may be determined as the syntax element corresponding to the last position of the significant transformation coefficient.

That is, when coordinates (x,y) corresponding to a last position 1710 determined with respect to a first point 1701 is

(x, y)=(last_significant_coeff_x, last_significant_coeff_y_), the coordinates (Last_x_rev, Last_x_rev) corresponding to the last position encoded with respect to the second point 1702 may be determined as below.

(Last_{—}x_{—}rev,Last_{—}x_{—}rev)=(tsize−1−last_significant_coeff_{—}x,tsize−1−last_significant_coeff_{—}y)

Here, tsize may represent a horizontal or vertical size of the coding unit.

By using the above-described method, in loss coding, the number of bits allocated to encode the last position may be reduced.

Meanwhile, according to another exemplary embodiment, a method of determining position information corresponding to a last position of a significant transformation coefficient described above with respect to the second point may not be always applied in video encoding and decoding but may be selectively applied by comparing a distance from the first point to the last position and a distance from the second point to the last position.

FIG. 14C is a flowchart of a method of encoding a last position of significant residual data in lossless coding according to an exemplary embodiment.

FIG. 14C illustrates an exemplary embodiment in which transformation and quantization are both bypassed in loss coding according to an exemplary embodiment to thereby entropy encode residual data itself. Compared to FIG. 14B, since the difference is only that residual data of a coding unit for which transformation is bypassed is input instead of a transformation coefficient of a transformation unit, description will focus on differences only.

In operation 1416, the scanner 1410 according to an exemplary embodiment may perform scanning from a first point to a second point of a coding unit in a predetermined order to thereby obtain residual data included in the coding unit.

Here, the first point may be an upper left corner of the coding unit, and the second point may be a lower right corner of the coding unit. Meanwhile, if transformation is bypassed, no high frequency region exists in the coding unit; however, according to the present exemplary embodiment, residual data may be regarded and processed as a transformation coefficient of FIG. 18B, and thus, when assuming that transformation is performed, the first point may correspond to a position corresponding to a low frequency position of the coding unit, and the second point may correspond to a position corresponding to a high frequency position of the coding unit.

In operation 1426, the last position determiner 1420 according to an exemplary embodiment may determine a last position of residual data that is not 0 from among coefficients included in the coding unit.

In operation 1436, the position information determiner 1430 according to an exemplary embodiment may determine position information corresponding to the determined last position with respect to the second point 1502. Also, in operation 1446, the encoder 1440 according to an exemplary embodiment may encode the determined position information.

FIG. 18A is a block diagram illustrating an apparatus for decoding a last position of a significant transformation coefficient or significant residual data in lossless coding according to an exemplary embodiment. FIG. 18B is a flowchart of a method of decoding a last position of a significant transformation coefficient in lossless coding according to an exemplary embodiment. FIG. 18C is a flowchart of a method of decoding a last position of significant residual data in lossless coding according to an exemplary embodiment.

In the apparatus for decoding a last position of a significant transformation coefficient or significant residual data illustrated in FIG. 18A (hereinafter, “last position decoding apparatus 1800”), only elements that are related to the present exemplary embodiment are illustrated. Thus, it will be obvious to one of ordinary skill in the art that other general-use elements may be further included in addition to the elements illustrated in FIG. 18A. The last position decoding apparatus 1800 corresponds to the entropy decoder 220 of the video decoding apparatus 200 of FIG. 2. The last position decoding apparatus 1800 performs a reverse process to the encoding process performed by the last position encoding apparatus 1400 described above. Thus, it will be obvious to one of ordinary skill in the art that, although not describe below, operations needed to perform a reverse process to the encoding process performed by the last position encoding apparatus 1400 may be further performed.

Referring to FIG. 18A, a position information obtaining unit 1810 and a last position determiner 1820 may be included.

Hereinafter, an example of an operation of the last position decoding apparatus 1800 will be described in detail with reference to FIG. 18B.

In operation 1815, the position information obtaining unit 1810 according to an exemplary embodiment may obtain position information corresponding to a last position of a significant transformation coefficient included in a transformation unit, from a bit stream. The obtained position information may be a value corresponding to a distance between a high frequency region of the coding unit and the last position. That is, the position information obtaining unit 1810 may obtain a syntax element that is encoded with respect to the second point described above (1520 of FIG. 15, 1720 of FIG. 17).

In operation 1825, the last position determiner 1520 according to an exemplary embodiment may determine the last position based on the obtained position information. For example, when the position information obtaining unit 1810 in FIG. 17 obtains (Last_x_rev, Last_y_rev) as position information, coordinates (x, y) corresponding to the last position 1710 may be reconstructed as below with respect to the first point 1701.

(x,y)=(tsize−1−Last_{—}x_{—}rev,tsize−1−Last_{—}y_{—}rev)

Later, the video decoding apparatus 200 according to an exemplary embodiment may decode a transformation coefficient included in a transformation unit starting from the obtained last position.

Hereinafter, another example of an operation of the last position decoding apparatus 1800 will be described in detail with reference to FIG. 18C.

FIG. 18C illustrates an exemplary embodiment in which residual data itself is entropy decoded by bypassing both transformation and quantization in lossless coding. Compared to FIG. 18B, since the difference is only that data to be obtained by decoding a bit stream is residual data for which transformation is bypassed, instead of a significant transformation coefficient, description will focus on differences only.

In operation 1816, the position information obtaining unit 1810 according to an exemplary embodiment may obtain position information corresponding to a last position of significant residual data included in a coding unit, from a bit stream. The obtained position information may be a value corresponding to a distance between a position corresponding to a high frequency region of the coding unit and the last position. That is, if transformation is bypassed, no high frequency region exists in the coding unit; however, residual data according to the present exemplary embodiment may be regarded and processed as the transformation coefficient of FIG. 18B, and thus, a value corresponding to a distance from a position corresponding to a high frequency region to a last position of significant residual data may be encoded as position information.

In operation 1826, the last position determiner 1520 according to an exemplary embodiment may determine the last position based on the obtained position information.

As described above, according to the method of encoding and decoding a last position of a significant transformation coefficient according to an exemplary embodiment, a coding size of entropy coding corresponding to the last position of the significant transformation coefficient in lossless coding may be reduced, and a speed of encoding and decoding may be increased.

The inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. Also, the computer readable recording medium can also be distributed over network coupled computer systems so that the computer readable code is stored and executed in a distributed fashion.

While the inventive concept has been particularly shown and described with reference to preferred exemplary embodiments thereof, it will be understood by those skilled in the art that various changes in form and details may be made therein without departing from the spirit and scope of the inventive concept as defined by the appended claims. The preferred exemplary embodiments should be considered in descriptive sense only and not for purposes of limitation. Therefore, the scope of the inventive concept is defined not by the detailed description of the inventive concept but by the appended claims, and all differences within the scope will be construed as being included in the inventive concept.

1. An encoding method for encoding a last position of a significant transformation coefficient in lossless coding, the encoding method comprising:
performing scanning from a first point to a second point of a coding unit in a predetermined order to obtain a transformation coefficient included in the coding unit;
determining a last position of a significant transformation coefficient that is not 0 from among transformation coefficients included in the coding unit;
determining position information corresponding to the determined last position with respect to the second point; and
encoding the determined position information.

2. The encoding method of claim 1, wherein the position information is a value corresponding to a distance from the second point to the determined last position.

3. The encoding method of claim 2, wherein the position information is coordinate values corresponding to the determined last position with respect to the second point as the origin.

4. The encoding method of claim 1, wherein the first point is an upper left corner of the coding unit, and the second point is lower right corner of the coding unit.

5. The encoding method of claim 1, wherein the first point is a low frequency position of the coding unit, and the second point is a high frequency position of the coding unit or a position corresponding to the high frequency position.

6. A decoding method for decoding a last position of a significant transformation coefficient in lossless coding, the decoding method comprising:
obtaining position information corresponding to a last position of a significant transformation coefficient included in a coding unit from a bit stream; and
determining the last position based on the obtained position information,
wherein the obtained position information is a value corresponding to a distance from a high frequency region of the coding unit to the last position.

7. The decoding method of claim 6, wherein the position information is coordinate values corresponding to the last position having a lower right corner of the coding unit as the origin.

8. A computer readable recording medium having recorded thereon a program for executing the encoding method of claim 1.

9. A computer readable recording medium having recorded thereon a program for executing the decoding method of claim 6.

10. An encoding apparatus for encoding a last position of a significant transformation coefficient in lossless coding, the encoding apparatus comprising:
a scanner configured to perform scanning from a first point to a second point of a coding unit in a predetermined order to obtain a transformation coefficient included in the coding unit;
a last position determiner configured to determine a last position of a significant transformation coefficient that is not 0 from among coefficients included in the coding unit;
a position information determiner configured to determine position information corresponding to the determined last position with respect to the second point; and
an encoder configured to encode the determined position information.

11. The encoding apparatus of claim 10, wherein the position information is a value corresponding to a distance from the second point to the determined last position.

12. A decoding apparatus for decoding a last position of a significant transformation coefficient in lossless coding, the video decoding apparatus comprising:
a position information obtaining unit configured to obtain position information corresponding to a last position of a significant transformation coefficient included in a coding unit from a bit stream; and
a last position determiner configured to determine the last position of the significant transformation coefficient based on the obtained position information,
wherein the obtained position information is a value corresponding to a distance from a high frequency region of the coding unit to the last position.

13. An encoding method for encoding a last position of a significant transformation coefficient in lossless coding, the encoding method comprising:
performing scanning from a first point to a second point of a coding unit in a predetermined order to obtain residual data included in the coding unit;
determining a last position of significant residual data that is not 0 from among residual data included in the coding unit;
determining position information corresponding to the determined last position with respect to the second point; and
encoding the determined position information.

14. A decoding method for decoding a last position of significant residual data in lossless coding, the decoding method comprising:
obtaining position information corresponding to a last position of significant residual data included in a coding unit from a bit stream; and
determining the last position based on the obtained position information,
wherein the obtained position information is a value corresponding to a distance from a high frequency region of the coding unit to the last position.
